(19) United States
(12) Patent Application Publication
(10) Pub. No.: US 2026/0295549 A1
(43) Pub. Date: Oct. 1, 2026

(54) CONTINUOUS FLUIDIZED-BED, FLASH JOULE HEATING REACTOR AND METHOD FOR HALOGENATION OF METAL-CONTAINING FEEDS

(71) Applicant: FLASH METALS USA INC., Houston, TX (US)

(72) Inventors: Clifton T. KNIGHT, League City, TX (US); Aaron KNIGHT, League City, TX (US); Kobus J.A. STADLER, Houston, TX (US)

(21) Appl. No.: 19/450,371

(22) Filed: Jan. 15, 2026

Related U.S. Application Data
(60) Provisional application No. 63/101,198, filed on Jan. 22, 2025.
(60) Provisional application No. 63/924,103, filed on Nov. 24, 2025.

(51) Int. Cl. B01J 8/18; B01J 8/00; B01J 8/38; C01D 15/04

(52) U.S. Cl. CPC B01J 8/1836; B01J 8/003; B01J 8/0065; B01J 8/1827; B01J 8/382; C01D 15/04; B01J 2208/00362; B01J 2208/00389; B01J 2208/00752; B01J 2208/00761; B01J 2208/0084; B01J 2208/00867; B01J 2208/00893; B01J 2208/00938; B01J 2208/00991

(57) ABSTRACT

A method for forming a metal halide includes introducing a feedstock and a halogen gas into a reactor system including a reactor, the feedstock including a metal, the reactor oriented vertically, the reactor having an outer wall, an inner liner, and an interior. The method also includes heating the feedstock and the halogen gas using induction coils, the induction coils wrapped around the outer wall of the reactor. In addition, the method includes reacting the feedstock and the halogen gas to form the metal halide, wherein the metal halide includes both a solid metal halide and a gaseous metal halide. Further, the method includes displacing solids from the reactor through a distributor, the distributor located within the interior of the reactor and cooling the gaseous metal halide with a cooler, the cooler connected to the reactor.

### CROSS-REFERENCE TO RELATED APPLICATIONS

This application is a nonprovisional application which claims priority from U.S. provisional application No. 63/101,198, filed Jan. 22, 2025, and 63/924,103, filed Nov. 24, 2025, each of which is incorporated by reference herein in its entirety.

### TECHNICAL FIELD/FIELD OF THE DISCLOSURE

The present disclosure relates generally to processing of materials containing metals.

### BACKGROUND OF THE DISCLOSURE

There are many different traditional methods of separating metals from such starting materials as ores, mine tailings, manufacturing and production scrap, waste streams, recycle streams, electronic waste, and black mass. These traditional methods often have low efficiencies in that much of the metal may be left in the starting materials. Traditional methods consume significant amounts of energy, acid/base reagents, and water and are often environmentally toxic. Thus, such traditional methods may result in valuable metals being unrecovered and toxic ending materials.

### SUMMARY

The disclosure includes a method for forming a metal halide. The method includes introducing a feedstock and a halogen gas into a reactor system including a reactor, the feedstock including a metal, the reactor oriented vertically, the reactor having an outer wall, an inner liner, and an interior. The method also includes heating the feedstock and the halogen gas using induction coils, the induction coils wrapped around the outer wall of the reactor. In addition, the method includes reacting the feedstock and the halogen gas to form the metal halide, wherein the metal halide includes both a solid metal halide and a gaseous metal halide. Further, the method includes displacing solids from the reactor through a distributor, the distributor located within the interior of the reactor and cooling the gaseous metal halide with a cooler, the cooler connected to the reactor.

In another embodiment, the disclosure includes a method for forming a metal halide in a drop tube reactor system. The method includes supplying a drop tube reactor system, the drop tube reactor system including a drop tube reactor, the drop tube reactor oriented vertically, the reactor having an outer wall, an inner liner, a top, and an interior. In addition, the method includes introducing a solid feedstock through a drop tube, the drop tube inserted into the top of the drop tube reactor. Also, the method includes introducing a halogen gas into the drop tube reactor and counter-flowing the halogen gas and the solid feedstock within the drop tube. The method also includes heating the halogen gas and the solid feedstock within the drop tube using tube induction coils, the tube induction coils wrapped around the drop tube and reacting the feedstock and the halogen gas to form the metal halide, wherein the metal halide includes both a solid metal halide and a gaseous metal halide. In addition, the method includes displacing solids from the reactor through a distributor, the distributor located within the interior of the drop tube reactor and cooling the gaseous metal halide with a cooler, the cooler connected to the drop tube reactor.

In yet another embodiment, the disclosure includes a method for forming a metal halide in an inductively heated cyclone reactor system. The method includes supplying a cyclone reactor system. The cyclone reactor system includes a cyclone reactor, the cyclone reactor oriented vertically, the cyclone reactor having an outer wall, an inner liner, and an interior. In addition, the cyclone reactor system includes a feed inlet valve, an eductor feed connector connected to the feed inlet valve, and an eductor, the eductor connected to the eductor feed connector. Also, the cyclone reactor system includes a static mixer, the static mixer connecting the eductor to the cyclone reactor and a cyclone, the cyclone positioned within an interior of the cyclone reactor and connected to the static mixer. Further, the cyclone reactor system includes induction coils, the induction coils wrapped around the outer wall of the cyclone reactor. The method also includes introducing a halogen gas into the cyclone reactor through a distributor, the distributor located within the interior of the cyclone reactor and introducing particulate feedstock containing a metal into the feed inlet valve and into the eductor. In addition, the method includes entraining the particulate feedstock with the halogen gas within the eductor and heating the feedstock and the halogen gas using induction coils. Further, the method includes reacting the feedstock and the halogen gas to form the metal halide, wherein the metal halide includes both a solid metal halide and a gaseous metal halide and cooling the gaseous metal halide with a cooler, the cooler connected to the cyclone reactor.

In still another embodiment, the disclosure includes a method for forming a metal halide in a rotating flash joule heater. The method includes supplying the rotating flash joule heater. The rotating flash joule heater includes a drum reactor, the reactor oriented between 0.5° and 6° to a horizontal axis, the drum reactor having an outer wall, an inner liner, and an interior, the drum adapted to rotate. The rotating flash joule heater also includes induction coils, the induction coils wrapped around the outer wall of the drum reactor and a cooler, the cooler connected to the drum reactor. The method also includes rotating the drum reactor and introducing a halogen gas into the drum reactor through a gas inlet port. In addition, the method includes introducing particulate feedstock containing a metal into a feed inlet valve and heating the feedstock and the halogen gas using the induction coils. Further, the method includes reacting the feedstock and the halogen gas to form the metal halide, wherein the metal halide includes a gaseous metal halide and cooling the gaseous metal halide with the cooler.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is side view of a reactor system consistent with certain embodiments of the present disclosure.

FIG. 2 is a side view of a drop tube reactor system consistent with certain embodiments of the present disclosure.

FIG. 3 is a side view of an inductively heated cyclone reactor system consistent with certain embodiments of the present disclosure.

FIG. 4 is a side view of a distributor located within a reactor of the reactor system, consistent with certain embodiment of the present disclosure.

FIG. 5 is a side view of a rotating flash joule heating system consistent with certain embodiments of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

In certain embodiments of the present disclosure, a metal extraction apparatus and process are described that uses inductive heating or inductive and ohmic heating to convert metals in a feedstock into gaseous form. In certain embodiments, the process may produce halide brines from condensed vapors and aqueous wash solutions of residual solid halides.

In some embodiments, the feedstock may be combined within the reactor with a halogen gas, such as fluorine, chlorine, bromine, iodine, or combinations thereof. Examples of such feedstocks may include ores, electronic waste, black mass, lanthanide bearing ores, lanthanide concentrate, spodumene, bauxite residue (for example, red mud), coal fly ash, gold tailings, rare earth element tailings and fines, and production scrap from processes utilizing indium, gallium, or germanium. As used herein, “black mass” refers to material recovered from end-of-life lithium-ion batteries during recycling. For example, rare earth element tailings and fines may be formed in mining and concentrating of rare earth bearing minerals, such as, for example and without limitation, bastnasite, monazite, ionic clay, and eudialyte. Such rare earth tailings and fines may include between, for example, 200 ppm and 25% by weight of a rare earth element. Rare earth metals include lanthanum, cerium, praseodymium, neodymium, promethium, samarium, europium, gadolinium, terbium, dysprosium, holmium, erbium, thulium, ytterbium, lutetium and scandium. Other metals in the feedstock may include precious metals such as gold, silver, platinum, and palladium. Following reaction, condensed off-gas and washed solids may generate metal-halide brines suitable for subsequent concentration, refinement, separation, and hydrometallurgical recovery operations.

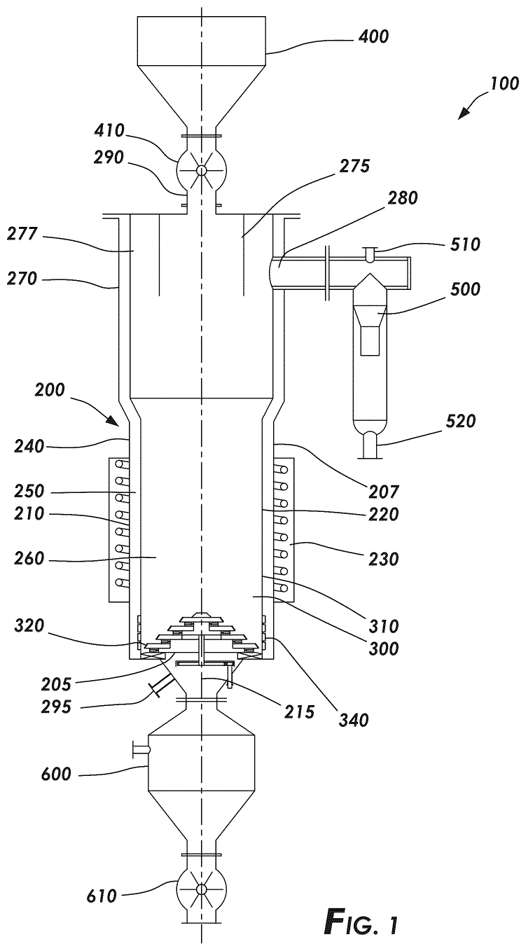

Reactor system 100 useful in the present disclosure may be found in FIG. 1. Reactor system 100 includes reactor 200. Reactor 200 may be vertically oriented. In certain embodiments, reactor 200 may be a fluidized-bed reactor. Reactor 200 may include outer wall 210 and inner liner 220. Outer wall 210 and inner liner 220 may be cylindrical. In some embodiments, as the contents of reactor 200 may include halogens at temperatures elevated from ambient, inner liner 220 may be halogen resistant. Examples of inner liners 220 may include nitrided or sintered silicon carbide, quartz, or other high-temperature halogen-resistant ceramic materials. Outer wall 210 may be constructed of any suitable metal including carbon, low alloy, or stainless steel. In some embodiments, reactor 200 may have external insulation 207 attached to outer wall 210. Flow through reactor 200 may in certain embodiments, form a fluidized bed, for example, a fast fluidized bed or a turbulent fluidized bed. A fast fluidized bed may be 20-100× Umf, where Umf is the minimum fluidization velocity. Umf represents the lowest upward gas velocity where solid particles become suspended and start to move freely, transitioning from a fixed bed to a fluid-like state. A turbulent fluidized bed may be from 5-20× Umf.

Reactor 200 may also include coils 230 wrapped around outer wall 210. Coils may be induction coils, resistive coils, ohmic coils, or combinations thereof. During operation, when coils 230 are induction coils, coils 230 may induce a magnetic field that creates an electrical current within outer wall 210, causing it to heat and therefore heat the contents of reactor 200.

Reactor 200 may include reactor bed 310. In some embodiments, as further described below, superficial gas velocity through reactor 200 may be below the range necessary for fluidization and a fluidized zone in reactor bed 310 may not be formed. In other embodiments, such as otherwise described below, other flow regimes may be formed rather than a fluidized bed. Reactor bed 310 may include upper heating zone 240, central reaction zone 250, and lower cooling zone 260. Cold feed exchanges heat with the exiting hot product gas in upper heating zone 240. Exothermic halogenation of metal oxides and phosphates occurs in central reaction zone 250. In lower cooling zone 260, hot, reacted solids transfer heat to the incoming cold halogen.

Disengagement section 270 may be positioned adjacent and above upper heating zone 240. At least a portion of disengagement section 270 may be tapered such that the inner diameter of the non-tapered portion of disengagement section 270 may be greater than the inner diameter of upper heating zone 240. Without being bound by theory, the increased inner diameter of disengagement section 270 may increase the solid gas separation and reduce entrainment or carryover of fine particles into an off-gas stream. Disengagement section 270 may include annular gas-solid disengagement skirt 275. Gas-solid disengagement skirt 275 defines solid annular disengagement zone 277. Gas disengagement skirt 275 may be cylindrical or tapered. When tapered, gas disengagement skirt 275 may have a lower diameter smaller than an upper diameter and allow for solid feed to metal contact and cooling of the skirt as well as a larger diameter solid-gas interface and disengagement velocities. Gas may exit reactor 200 through gas outlet 280. Feedstock may enter reactor 200 through solids inlet 290.

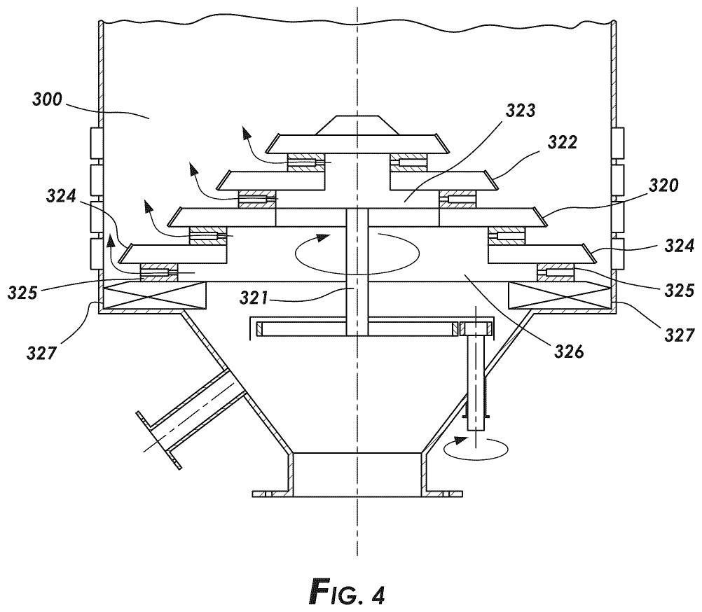

Distributor 320 may be positioned below reactor bed 310 within reactor interior 300. During operation, distributor 320 may be used to introduce a halogen gas into reactor interior 300. In some embodiments, distributor 320 is a rotating distributor adapted to introduce the halogen gas into the bed at a predetermined superficial velocity. Distributor 320 may be conical. In certain embodiments, such as the one depicted in FIG. 4, distributor 320 may include oriﬁces, plenums, and diffuser elements arranged at multiple elevations. Distributor 320 may include central pillar 321. Rotating grate 323 may be connected to central pillar 321 such that when central pillar 321 rotates, rotating grate 323 rotates. Rotating ribs 322 are mounted on rotating grate 323. Rotating grate 323 may include a series of interconnected rings sitting atop one another, each ring of decreasing diameter along the vertical axis. In certain embodiments, rotating grate may be an integrated piece. Rotating ribs 322 may be mounted on each ring of rotating grate 323. Each rotating rib may include overhang section 324. Overhang sections 324 may hang over orifices 325. Orifices 325 may fluidly communicate with rotating grate interior 326. The overhang sections 324 may act to reduce solids backflow into orifices 325. Without being bound by theory, overhang sections 324 above orifices 325 may prevent the backflow of solids into rotating grate 323 by allowing for an angle of repose-based seal to form.

Scrapers 327 may be connected to rotating grate 323 below the lowest rotating rib 322 and spaced about the circumference of rotating grate 323. In some embodiments, three to eight scrapers 327 may be used, which in some embodiments, may be positioned equidistant around the circumference of rotating grate 323. Scrapers 327 may displace solid material towards central pillar 321 and overcoming the angle of repose to discharge solid material through solids discharge cone 215. Central pillar 321 may be driven by a pinion gear, shaft and motor drive unit.

In certain embodiments, crushing ribs 340 may be mounted on inner liner 220. In these embodiments, rotating ribs 322 and crushing ribs 340 may crush solids between them.

In the embodiment shown in FIG. 1, solid feedstock is introduced through solids inlet 290 from feed hopper 400. Feed hopper 400 may communicate with reactor 200 through feed inlet valve 410. In certain non-limiting embodiments, feed inlet valve 410 may be a rotary valve. During operation, as the feed enters through feed inlet valve 410 and solids inlet 290, the feed falls into reactor bed 310.

As gas exits reactor 200 through gas outlet 280, gas may flow to cooler 500. In certain embodiments, cooler 500 is a direct injection quench cooler with a mixing throat. In other embodiments, cooler 500 is an indirect cooling-condenser or a series of direct cooling-condensers for staged cooling. During operation, water, cold chlorine or an inert gas may be injected through quench inlet 510 into cooler 500 to quench cool the product gas and condense metal chlorides in the product gas to a brine and knock out solid fines or other particles carried over in gas outlet 280. Brine may exit cooler 500 through brine discharge 520. Product gas that does not condense into the brine may also exit through brine discharge 520 as a three-phase flow containing solids, brines, and unreacted excess halogen and products of reaction gas.

Solids may exit reactor 200 from reactor bottom 205 through solids discharge cone 215. From solids discharge cone 215, solids are quenched and form a slurry that may gather in solids product hopper 600. The solids and quenched slurry may exit solids product hopper 600 through bottom valve 610, which in some embodiments may be a bottom rotary valve. In another embodiment, the solids discharge is not quenched.

In certain embodiments, halogen gas may be injected into reactor 200 through gas inlet port 295. In other embodiments, described below, gas may also be injected in other locations in reactor 200.

During operation, feedstock solids may enter reactor 200 from feed hopper 400. Halogen gas may enter reactor 200 through gas inlet port 295. The halogen gas may react with metals in the feedstock in accordance with the following reaction, which shows chlorine as the halogen gas:

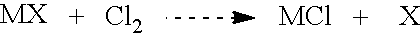

As a specific example, when reacting spodumene with chlorine gas:

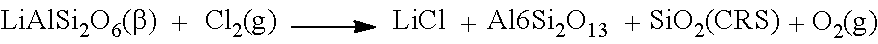

The reaction may be continuous. Reacted metal chlorides may be solids, liquids, gaseous, or combinations thereof. Solid metal halides may migrate or fall to reactor bottom 205 along with partially or unreacted feedstock. As described above, distributor 320 may allow the halogen gas to enter the reactor at a predetermined superficial velocity. Distributor 320 may also scrape solids to solids discharge cone 215, where the solids may exit the reactor. In addition, unreacted halogen gas in combination with gaseous metal halides may exit the reactor through gas outlet 280 and flow to cooler 500. Gaseous metal halides may be cooled, quenched, and separated from unreacted halogen gas in cooler 500.

In some embodiments where superficial gas velocity is lower than that needed to establish a fluidized bed within reactor 200, a bubbling bed may be established within reactor 200. For example, a bubbling bed may have a superficial gas velocity from 1-5× Umf. Distributor 320 may introduce the halogen gas in a way to create discrete gas bubbles that rise through an emulsion phase while solids remain in a dense, homogenous bed where discrete gas bubbles pass upward through an emulsion phase. Without being bound by theory, in the bubbling bed, solids remain in a dense, bubbling bed where mixing may be driven by bubble eruption and particle recirculation rather than bulk transport. By using a reduced superficial gas velocity compared to a fluidized bed, particle circulation may be reduced. Bubbling beds may be used, for example, with electronic-waste feedstocks such as shredded circuit boards, metallized polymers, and composites that may soften, fuse, or form lumps during halogenation. In addition, the reduced superficial gas velocity of a bubbling bed may be useful for feedstocks with discontinuous hardness or embedded metallic components that may be susceptible to fracture.

In yet other embodiments, a gas jet may be used within reactor 200 to form a spouted bed halogenation reactor. The gas jet may be formed of gas having a velocity of between 20 and 100 × Umf. The center region of reactor 200 where the gas jet may be located may have the spouted jet where the periphery may remain slow moving, comparative to the gas jet, and recirculating. In this embodiment, halogen gas may be injected in an inner orifice ring of distributor 320. When the gas jet is used, solids within reactor 200 may be lifted in a conical upward trajectory, i.e., a spout. Disengagement section 270 may serve as a freeboard and a gas-solid disengagement zone. Without being bound by theory, when a gas jet is used, solids lifted by the jet may fall along inner liner 220, creating an annular downward flow path that recirculates solids between the central spout and the peripheral bed. The gas jet embodiment may be used with irregular, coarse, or high-density feed materials that may not otherwise fluidize uniformly.

In other embodiments, reactor 200 may use a slow moving bed system. In the slow moving bed system, superficial and interstitial gas velocities may be lower than those of a fluidized bed, specifically less than 1× Umf. The halogen gas may be injected into reactor 200 through distributor 320. The gas then flows through inter-particle void spaces at velocities of less than 1× Umf. In certain embodiments, the slow moving bed system may operate below fluidization onset, maintain a stable granular column, and promote gas-solid interaction through diffusion and displacement within the void network. The slow moving bed system may be useful for feedstocks for dense, fused, or geometrically irregular materials.

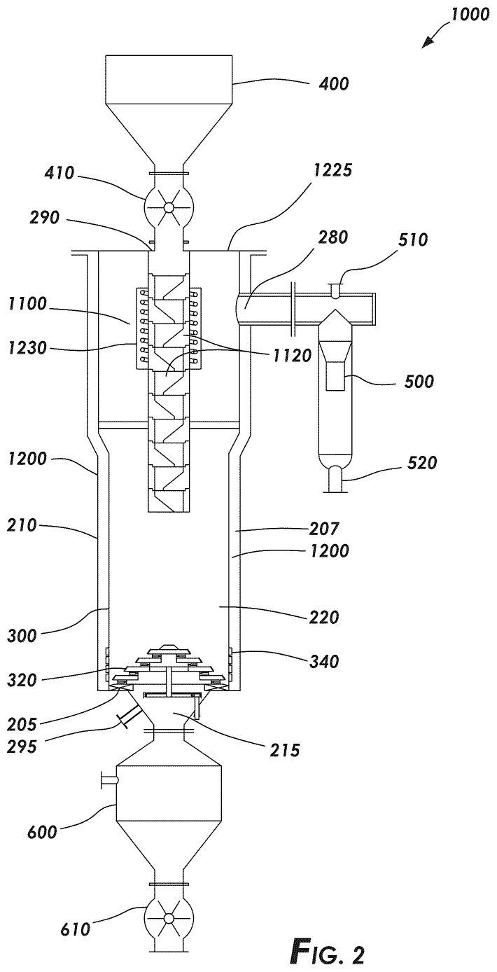

In still another embodiment, drop tube reactor system 1000, shown in FIG. 2, may be used to halogenate metals in metal-containing feedstocks. Drop tube reactor system 1000 may include drop tube reactor 1200. Elements with the same numbers as reactor system 100 are the same as used in drop tube reactor system 1000.

Drop tube reactor 1200 may include drop tube 1100. Drop tube 1100 may be a cylindrical or rectangular tube inserted into top 1225 of drop tube reactor 1200. Drop tube 1100 may include a series of inclined baffle plates 1120 positioned within the interior of the drop tube. The inclination of the inclined baffle plates as measured from the horizontal plane may be the same or different and may be greater than the repose angle of the feed material, i.e., the steepest stable slope loose granular material can form before particles begin sliding due to gravity. The baffles may form a stepwise, cascading descent path for particles entering from feed hopper 400. In the embodiment shown in FIG. 2, tube induction coils 1230 wrapped around drop tube 1100 may heat drop tube 1100, heating particles traveling through drop tube 1100 during operation. Halogen gas may flow counter-flow to the solids through drop tube 1100.

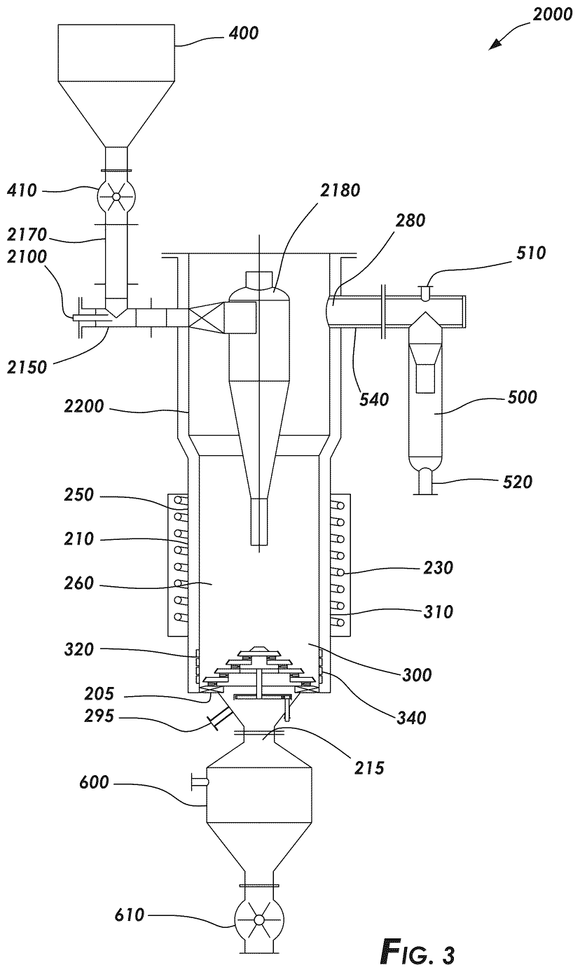

In yet another embodiment, inductively heated cyclone reactor system 2000, shown in FIG. 3, may be used to halogenate metals in metal-containing feedstocks. Inductively heated cyclone reactor system 2000 may include cyclone reactor 2200. Elements with the same numbers as reactor system 100 are the same as used in inductively heated cyclone reactor system 2000. Inductively heated cyclone reactor system 2000 may include eductor 2100 positioned between feed inlet valve 410 and cyclone reactor 2200, where eductor 2100 is connected to feed inlet valve 410 via eductor feed connector 2170. Eductor 2100 may entrain particles from feed hopper 400 into a halogen gas stream. Static mixer 2150 may connect eductor 2100 with cyclone reactor 2200 to disperse the gas and solids before entering cyclone reactor 2200. Cyclone 2180 may extend from static mixer 2150, which extends into cyclone reactor 2200.

In the embodiment shown in FIG. 3, discharge pipe 540 connects gas outlet 280 to cooler 500. Further, in the embodiment shown in FIG. 3, cyclone 2180, static mixer 2150, eductor feed connector 2170 and discharge pipe 540 are encompassed within an induction field caused by induction coils 230. During operation, the induction field may maintain temperatures above the condensation point of the metal chlorides formed within cyclone reactor 2200.

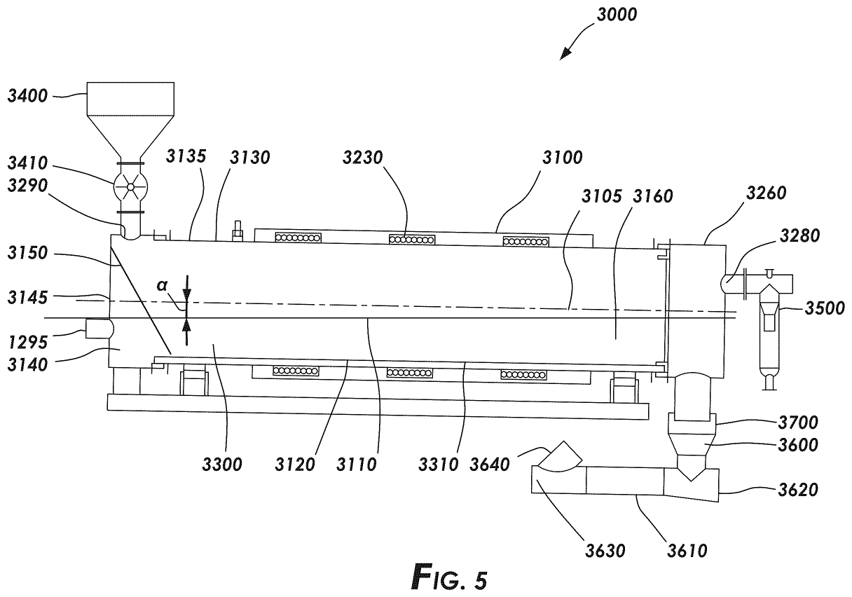

FIG. 5 depicts rotating flash joule heater 3000 consistent with certain embodiments of the present disclosure. Rotating flash joule heater 3000 may include drum reactor 3100. Drum reactor 3100 may be a horizontal, rotating, cylindrical drum. In certain embodiments, drum reactor 3100 may rotate about centerline 3105, such as by for instance, a girth gear fitted around drum reactor 3100 with a motor drive to allow slow rotation. In certain embodiments, centerline 3105 of drum reactor 3100 may be inclined relative to horizontal 3110 at angle α, wherein α is between 0.5° and 6°. Drum reactor 3100 may include inner liner 3120. Inner liner 3120 may be nitrided or sintered silicon carbide, quartz, or other high-temperature halogen-resistant ceramic materials. Outer wall 3130 may be constructed of any suitable metal including carbon, low alloy, exotic metals defined as alloys of niobium and molybdenum, alloys of nickel-iron-chromium such as Incoloy, alloys of nickel-chromium-molybdenum such as Hastelloy, hafnium, zirconium, tungsten, and tantalum, or stainless steel. In some embodiments. In some embodiments, drum reactor 3100 may have external insulation 3135 attached to outer wall 3130.

Drum reactor 3100 may also include coils 3230 wrapped around outer wall 3130. Coils may be induction coils, resistive coils, ohmic coils, or combinations thereof. During operation, when coils 3230 are induction coils, coils 3230 may induce a magnetic field that creates an electrical current within outer wall 3130, causing it to conduct heat and therefore heat the contents of drum reactor 3100.

Drum reactor 3100 may include front hood 3140. Solid feedstock may be introduced through solids inlet 3290 from feed hopper 3400. Feed hopper 3400 may communicate with drum reactor 3100 through feed inlet valve 3410. In certain non-limiting embodiments, feed inlet valve 3410 may be a rotary valve. During operation, as the feed enters through feed inlet valve 3410 and solids inlet 3290, the feed falls into drum interior 3300.

Drum reactor 3100 may include gas inlet port 1295 through which halogen gas is injected into drum reactor 3100. Baffle 3150 may be positioned within drum interior 3300 beneath solids inlet 3290. Baffle 3150 may be at an acute angle relative to hood front 3145. During operation, as halogen gas is injected into drum reactor 3100, the halogen gas contacts and reacts with solid feedstock from feed inlet valve 3410, facilitated by baffle 3150. In some embodiments, drum interior may include lifting flights 3310. Lifting flights 3310 may lift, cascade, and/or tumble solids from the solid feed to increase gas-solid heat transfer, expose fresh reactive surfaces, and maintain bed mobility. The halogen gas may react with the metals in the feed to form vaporous metal halides. The vaporous metal halides may exit from rear hood 3260 through gas outlet 3280, to cooler 3500. In certain embodiments, cooler 3500 is a direct injection quench cooler, such as a venturi quench cooler. In other embodiments, cooler 3500 is an indirect cooling condenser.

Residual solids may exit drum reactor 3100 through rear hood 3160 via gravity drop tube 3600, which may be connected to solids duct 3610. Solids duct 3610 may include gravity drop 3620 for oversized particles and pneumatic-pickup port 3630 connected to induced-draft fan port 3640. Residual solids may subsequently be conveyed to a product cooler or an aqueous washing system that dissolves remaining metal chlorides into a brine solution.

An induced-draft (ID) fan may be connected to the outlet of cooler 3500 system to extract product gases and residual chlorine from the FJH Calciner. Drum reactor 3100 may operate under neutral to negative pressure to allow containment of halogen gases and to minimize leakage of ambient air into high-temperature reaction zones within drum reactor 3100.

An ID fan may also be connected to solids duct 3610 for pneumatic solids conveying. Air gap 3700 may be provided between the gravity drop tube 3600 and solids duct 3610 to permit neutral pressure balance between hot reactor gas and cooler conveying air, restricting undesirable mixing or backflow.

Depending on the context, all references herein to the “disclosure” may in some cases refer to certain specific embodiments only. In other cases it may refer to subject matter recited in one or more, but not necessarily all, of the claims. While the foregoing is directed to embodiments, versions and examples of the present disclosure, which are included to enable a person of ordinary skill in the art to make and use the disclosures when the information in this patent is combined with available information and technology, the disclosures are not limited to only these particular embodiments, versions and examples. Other and further embodiments, versions and examples of the disclosure may be devised without departing from the basic scope thereof and the scope thereof is determined by the claims that follow.

1. A method for forming a metal halide comprising:
introducing a feedstock and a halogen gas into a reactor system including a reactor, the feedstock including a metal, the reactor oriented vertically, the reactor having an outer wall, an inner liner, and an interior;
heating the feedstock and the halogen gas using induction coils, the induction coils wrapped around the outer wall of the reactor;
reacting the feedstock and the halogen gas to form the metal halide, wherein the metal halide includes both a solid metal halide and a gaseous metal halide;
displacing solids from the reactor through a distributor, the distributor located within the interior of the reactor; and
cooling the gaseous metal halide with a cooler, the cooler connected to the reactor.

2. The method for forming a metal halide of claim 1, wherein the inner liner is nitrided or sintered silicon carbide or quartz.

3. The method for forming a metal halide of claim 1 further comprising forming a fluidized zone within the reactor, the fluidized zone including an upper heating zone, a central reaction zone, and a lower cooling zone.

4. The method for forming a metal halide of claim 3, further comprising separating the solid metal halide from the gaseous metal halide using a disengagement section within the reactor, wherein the disengagement section is positioned above the upper heating zone, the disengagement section tapered such that an inner diameter of the reactor is smaller than an inner diameter of the disengagement section.

5. The method for forming a metal halide of claim 4, wherein the disengagement section includes an annular gas-solid disengagement skirt.

6. The method for forming a metal halide of claim 1, wherein the distributor is a rotating, conical distributor.

7. The method for forming a metal halide of claim 6 further comprising driving the distributor using a gear motor coupled to a pinion-girth assembly.

8. The method for forming a metal halide of claim 1 wherein the feed stock is introduced through a solids inlet, the reactor system further comprising:
a feed hopper, the feed hopper positioned above the reactor; and
a feed inlet valve, the feed inlet valve connecting the solids inlet to the feed hopper.

9. The method for forming a metal halide of claim 8, wherein the feed inlet valve is a rotary valve.

10. The method for forming a metal halide of claim 1, wherein the cooler is a direct injection quench cooler or an indirect cooling-condenser.

11. The method for forming a metal halide of claim 10, further comprising injecting water into the cooler to quench cool the gaseous metal halide and condense the gaseous metal halide into a brine.

12. The method for forming a metal halide of claim 1, wherein the reactor includes a solids discharge port, the reactor system further comprising:
a bottom valve, the bottom valve connected to the solids discharge port; and
a solids product hopper, the solids product hopper connected to the bottom valve.

13. The method for forming a metal halide of claim 1, further comprising forming a bubbling bed.

14. The method for forming a metal halide of claim 1, wherein the distributor further includes a diffuser, the diffuser including an inner orifice ring.

15. The method for forming a metal halide of claim 14 further comprising forming a gas jet within the reactor.

16. The method for forming a metal halide of claim 1 further comprising forming a slow moving packed-bed system.

17. A method for forming a metal halide in a drop tube reactor system comprising:
supplying a drop tube reactor system the drop tube reactor system including a drop tube reactor, the drop tube reactor oriented vertically, the reactor having an outer wall, an inner liner, a top, and an interior;
introducing a solid feedstock through a drop tube, the drop tube inserted into the top of the drop tube reactor;
introducing a halogen gas into the drop tube reactor;
counter-flowing the halogen gas and the solid feedstock within the drop tube;
heating the halogen gas and the solid feedstock within the drop tube using tube induction coils, the tube induction coils wrapped around the drop tube;
reacting the feedstock and the halogen gas to form the metal halide, wherein the metal halide includes both a solid metal halide and a gaseous metal halide;
displacing solids from the reactor through a distributor, the distributor located within the interior of the drop tube reactor; and
cooling the gaseous metal halide with a cooler, the cooler connected to the drop tube reactor.

18. The method for forming a metal halide of claim 17, wherein the drop tube is a cylindrical or rectangular tube.

19. The method for forming a metal halide of claim 18, wherein the drop tube further comprises a series of inclined plates within an interior of the drop tube.

20. The method for forming a metal halide of claim 19, wherein the inclined plates form a stepwise, cascading path.

21. A method for forming a metal halide in an inductively heated cyclone reactor system comprising:
supplying a cyclone reactor system, the cyclone reactor system including:
a cyclone reactor, the cyclone reactor oriented vertically, the cyclone reactor having an outer wall, an inner liner, and an interior;
a feed inlet valve;
an eductor feed connector connected to the feed inlet valve;
an eductor, the eductor connected to the eductor feed connector;
a static mixer, the static mixer connecting the eductor to the cyclone reactor;
a cyclone, the cyclone positioned within an interior of the cyclone reactor and connected to the static mixer; and
induction coils, the induction coils wrapped around the outer wall of the cyclone reactor;
introducing a halogen gas into the cyclone reactor through a distributor, the distributor located within the interior of the cyclone reactor;
introducing particulate feedstock containing a metal into the feed inlet valve and into the eductor;
entraining the particulate feedstock with the halogen gas within the eductor;
heating the feedstock and the halogen gas using induction coils;
reacting the feedstock and the halogen gas to form the metal halide, wherein the metal halide includes both a solid metal halide and a gaseous metal halide; and
cooling the gaseous metal halide with a cooler, the cooler connected to the cyclone reactor.

22. A method for forming a metal halide in a rotating flash joule heater comprising:
supplying the rotating flash joule heater, the rotating flash joule heater comprising:
a drum reactor, the reactor oriented between 0.5° and 6° to a horizontal axis, the drum reactor having an outer wall, an inner liner, and an interior, the drum adapted to rotate;
induction coils, the induction coils wrapped around the outer wall of the drum reactor; and
a cooler, the cooler connected to the drum reactor;
rotating the drum reactor;
introducing a halogen gas into the drum reactor through a gas inlet port;
introducing particulate feedstock containing a metal into a feed inlet valve;
heating the feedstock and the halogen gas using the induction coils;
reacting the feedstock and the halogen gas to form the metal halide, wherein the metal halide includes a gaseous metal halide; and
cooling the gaseous metal halide with the cooler.
